(19) United States
(12) Patent Application Publication
(10) Pub. No.: US 2007/0172712 A1
(43) Pub. Date: Jul. 26, 2007

(54) Pressure-adjustable fixture for fuel cell unit testing

(76) Inventors: Feng-Hsiang Hsiao, Taipei (TW); Ting-Yong Lai, Jhunan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/651,983

(22) Filed: Jan. 11, 2007

(30) Foreign Application Priority Data
Jan. 20, 2006 (TW) 95102352

(51) Int. Cl. H01M 8/04

(52) U.S. Cl. 429/25

(57) ABSTRACT

A pressure-adjustable fixture for fuel cell unit includes a controllable pressure source, a pressure guiding mechanism, a press plate, and a pressure-applying carrier mechanism. The controllable pressure source supplies an amount of pressure, which is transmitted via the pressure guiding mechanism to the press plate, and the pressure is further uniformly distributed via the press plate over the fuel cell units loaded on the pressure-applying carrier mechanism for testing. In this manner, the fuel cell units have optimal contact pressure to achieve the best electrical properties.

### FIELD OF THE INVENTION

The present invention relates to a fixture for fuel cell unit, and more particularly, to a pressure-adjustable fixture for fuel cell unit testing.

### BACKGROUND OF THE INVENTION

The consumption of conventional energy sources, such as coal, petroleum, and natural gas, is constantly increased with the highly developed human civilization, resulting in serious environmental pollution on earth and worsened environment deterioration factors, such as greenhouse effect and acid rain. In view of the limited and gradually depleted natural energy sources, many highly developed countries have devoted to the development of new and alternative energy sources. Among others, fuel cell stack is a very important, highly potential and practical choice. As compared with the conventional internal combustion engine, the fuel cell stack has many advantages, including high energy conversion efficiency, clean exhaust, low noise, completely fuel-oil-free, etc.

A fuel cell stack includes a plurality of fuel cell units. Finished fuel cell units and fuel cell stacks are subject to test. In conventional test procedures, the fuel cell units in each fuel cell stack are firmly bound together using a plurality of bolts, so as to accept performance curve test.

FIG. 1 is a perspective view showing a fuel cell system 100 bound in a conventional way for performance test. As shown, the fuel cell units 101 included in the fuel cell system 100 are assembled and bound together by a plurality of bolts 104. The fuel cell units 101 are protectively sandwiched between an upper protective plate 102 and a lower protective plate 103. The bolts 104 provide pressure needed to tightly bind the fuel cell units 101 together. FIG. 2 shows three representative performance curves A, B, and C, wherein the performance curve C represents a fuel cell unit having relatively high performance, the performance curve A represents a fuel cell unit having relatively low performance, and the performance curve B represents a fuel cell unit having normal performance.

With the plurality of bolts 104, the fuel cell units are provided with a contact pressure. When the contact pressure is insufficient, the fuel cell units could not be tightly bound together and would therefore result in leakage of water or gas, as well as increased contact resistance between any two adjacent layers of fuel cell units 101 and accordingly reduced performance of the fuel cell units, as the performance curve B or even A shown in FIG. 2. On the other hand, when the contact pressure is exceeded, the fuel cell units 101 would become deformed, warped, or even structurally destroyed. Therefore, the finished fuel cell units 101 subjected to performance test must be properly locked in place using bolts 104. However, the bolts 104 used to lock and bind the fuel cell units 101 together do not always provide pressure that enables the tested fuel cell units to show their best performance. Moreover, since the contact pressure is not a fixed parameter, the performance curve obtained from the performance test might be inaccurate.

As having been mentioned above, when the contact pressure is exceeded, the fuel cell units 101 might become warped and/or leaked. Particularly, when the contact pressure is improperly or unevenly distributed over the tested fuel cell units, the fuel cell stack would have a raised central area. Moreover, it is time-consuming and troublesome to lock and bind the tested fuel cell units with so many bolts, which inevitably increases the manufacturing cost.

### SUMMARY OF THE INVENTION

It is therefore a primary object of the present invention to provide a pressure-adjustable fixture for fuel cell unit, so that optimal contact pressure may be supplied from a controllable pressure source to a group of fuel cell units or a fuel cell stack to be tested.

Another object of the present invention is to provide a pressure-adjustable fixture for fuel cell unit testing, so as to increase the accuracy of performance curves of tested fuel cell units.

A further object of the present invention is to provide a pressure-adjustable fixture for fuel cell unit testing, so that fuel cell units to be tested may be held in place without the need of using a large number of fastening bolts, and always have optimal contact pressure in the testing before and after the fuel cell units are formally manufactured.

A still further object of the present invention is to provide a pressure-adjustable fixture for fuel cell unit testing, so that fuel cell units may be more easily and accurately assembled.

With the pressure-adjustable fixture for fuel cell unit according to the present invention, fuel cell units to be tested may be tightly bound and sandwiched between two protective plates without the need of taking a lot of time to troublesomely fasten a large number of bolts, and all the layers of the tested fuel cell units are ensured to parallelly and closely contact with one another. That is, the fuel cell units can be quickly and tightly bound for dynamically testing their performance to obtain the performance curves thereof. With the pressure-adjustable fixture of the present invention, the fuel cell unit may be more easily and accurately assembled to effectively overcome the problems often occurred in the conventional way of fuel cell unit testing, in which the fuel cell units to be tested are tightened between two protective plates by a large number of bolts.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing a conventional way of binding fuel cell units to be tested, in which the fuel cell units are bound between two protective plates using a plurality of bolts;

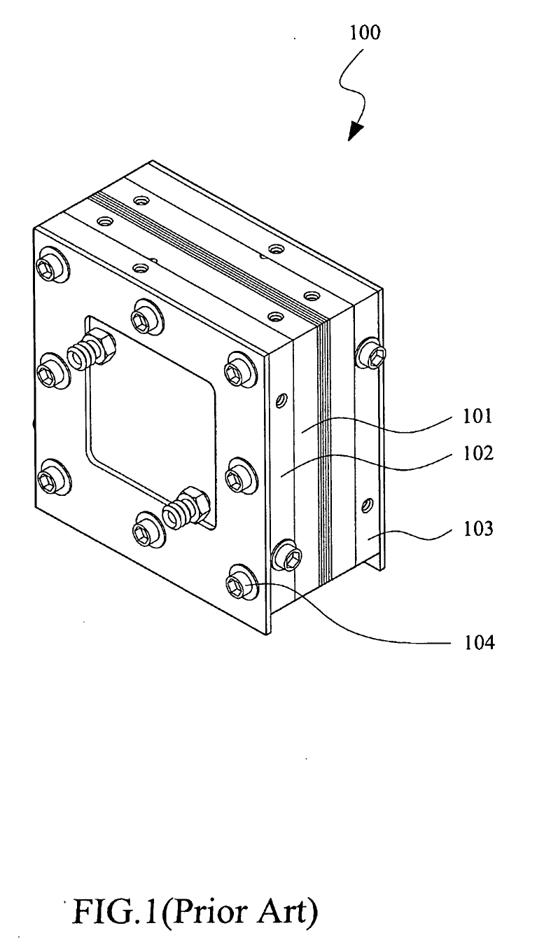

FIG. 2 shows three representative performance curves of fuel cell units;

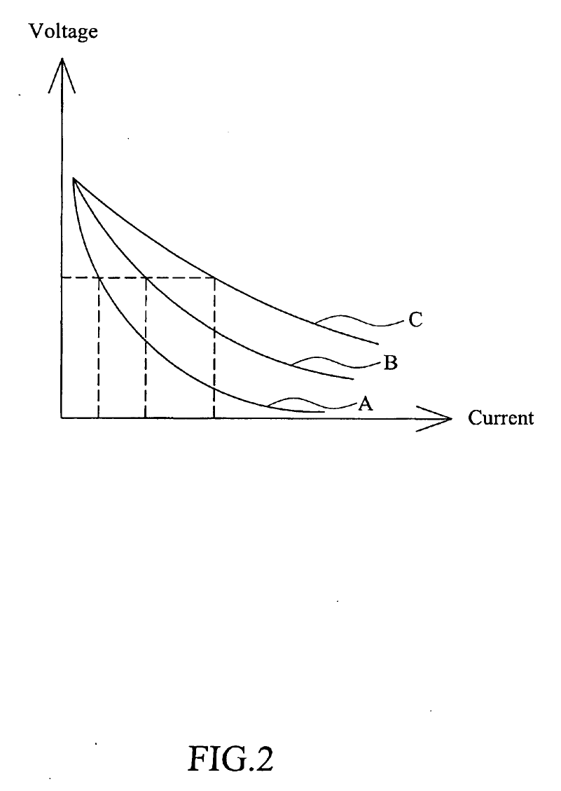

FIG. 3 is a perspective view of a pressure-adjustable fixture for fuel cell unit testing according to the present invention; and

FIG. 4 is a vertical sectional view of FIG. 3.

### DETAILED DESCRIPTION OF THE PREFERRED EMBODIMENTS

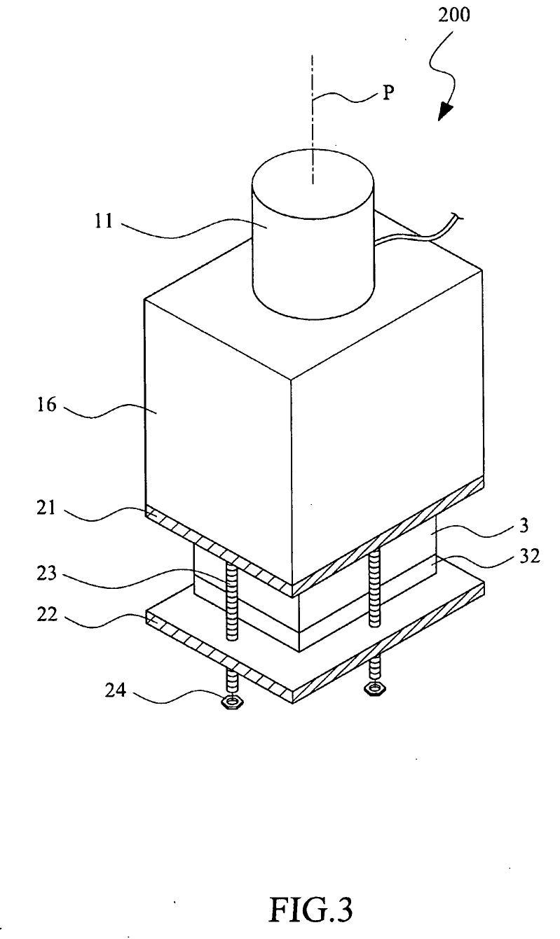

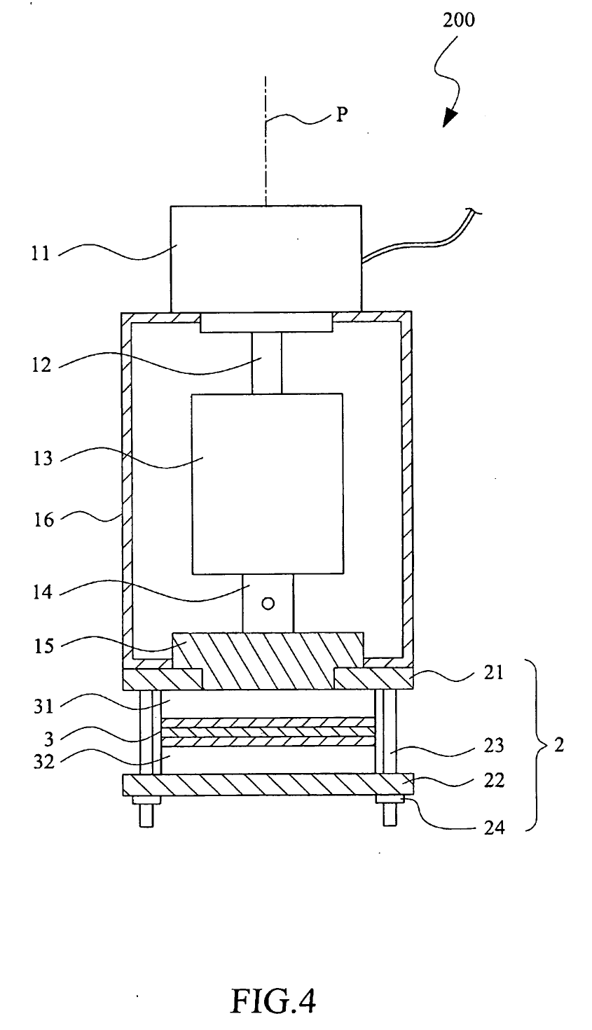

Please refer to FIGS. 3 and 4 that are perspective and vertical sectional views, respectively, of a pressure-adjustable fixture 200 according to the present invention. As shown, the pressure-adjustable fixture 200 is used to apply uniform pressure on a fuel cell unit or a group of fuel cell units 3, and includes a controllable pressure source 11, a transmission rod 12, a pressure guiding mechanism 13, a universal joint 14, a press plate 15, and a pressure-applying carrier mechanism 2. Wherein, the transmission rod 12, the pressure guiding mechanism 13, the universal joint 14, and the press plate 15 are enclosed in a fixture housing 16. The pressure-applying carrier mechanism 2 includes an upper carrier plate 21, a lower carrier plate 22, and a plurality of bolts 23. The controllable pressure source 11 may be an air press, an oil press, a manually controlled pressure device, or any device for supplying pressure, such as a motor or a manual driver.

To use the pressure-adjustable fixture 200, the controllable pressure source 11 is caused to supply an amount of pressure, which is transmitted to the pressure guiding mechanism 13 via the transmission rod 12 that is connected to the controllable pressure source 11.

The pressure guiding mechanism 13 receives the pressure come from the transmission rod 12, and guides the same pressure to the universal joint 14, which is connected to an end of the pressure guiding mechanism 13 opposite to the transmission rod 12. The universal joint 14 further guides the pressure come from the pressure guiding mechanism 13 to the press plate 15 connected to the universal joint 14 opposite to the pressure guiding mechanism 13. With the universal joint 14, pressure that is deviated from a vertical center axis P of the pressure-adjustable fixture 200 may be adjusted to become parallel with the vertical center axis P. As a result, the pressure supplied by the controllable pressure source 11 is always uniformly and parallelly guided to the press plate 15.

The group of fuel cell units 3 is loaded on the pressure-applying carrier mechanism 2 between the upper carrier plate 21 and the lower carrier plate 22. The upper and the lower carrier plate 21, 22 are bearing on an upper and a lower protective plate 31 located at two opposite sides of the group of fuel cell units 3, respectively. The pressure supplied by the controllable pressure source 11 and guided to the press plate 15 is uniformly distributed via the press plate 15 over the upper protective plate 31 of the fuel cell units 3, so the fuel cell units 3 located between the upper and the lower protective plate 31, 32 are bound together to tightly contact with one another. The plurality of bolts 23 of the pressure-applying carrier mechanism 2 are extended through the upper and the lower carrier plate 21, 22 and tightened, so as to locate the fuel cell units 3 on the pressure-applying carrier mechanism 2 at a predetermined position.

With the pressure-adjustable fixture for fuel cell unit testing according to the present invention, a group of fuel cell units to be tested may be tightly bound between two protective plates without the need of taking a lot of time to troublesomely fasten a large number of bolts, and all the layers of the tested fuel cell units are ensured to parallelly and closely contact with one another. That is, the fuel cell units can be quickly and tightly bound between the protective plates and then sandwiched between the upper and the lower carrier plate for dynamically testing their performance to obtain the performance curves thereof. With the pressure-adjustable fixture of the present invention, the fuel cell units in the test stage can be kept in tightly bound state while being moved among different testing apparatus, and pressure may be uniformly distributed over the fuel cell units before the same are fastened with bolts, so that the fuel cell units may be easily fastened and assembled in the subsequent procedures.

What is claimed is:

1. A pressure-adjustable fixture for uniformly distributing pressure over a fuel cell unit, comprising:
a controllable pressure source for supplying an amount of pressure and having a transmission rod;
a pressure guiding mechanism connected to the transmission rod of the controllable pressure source for transmitting the pressure supplied by the controllable pressure source; and
a press plate connected to the pressure guiding mechanism opposite to the transmission rod, so that the pressure supplied by the controllable pressure source and transmitted via the pressure guiding mechanism to the press plate is uniformly distributed over the fuel cell unit.

2. The pressure-adjustable fixture as claimed in claim 1, wherein the controllable pressure source is an air press.

3. The pressure-adjustable fixture as claimed in claim 1, wherein the controllable pressure source is an oil press.

4. The pressure-adjustable fixture as claimed in claim 1, further comprising a pressure-applying carrier mechanism, on which the fuel cell units to be tested are loaded.

5. The pressure-adjustable fixture as claimed in claim 4, wherein the pressure-applying carrier mechanism includes an upper carrier plate, a lower carrier plate located at a predetermined distance from the upper carrier plate for carrying the fuel cell units thereon, and a plurality of bolts extended through the upper and the lower carrier plate to firmly hold the fuel cell units to the pressure-applying carrier mechanism at a predetermined position.

6. The pressure-adjustable fixture as claimed in claim 1, wherein the pressure guiding mechanism includes a universal joint, via which the pressure supplied by the controllable pressure source and transmitted via the pressure guiding mechanism to the press plate is uniformly distributed over the fuel cell units.
